(19) United States
(12) Patent Application Publication
(10) Pub. No.: US 2012/0218938 A1
(43) Pub. Date: Aug. 30, 2012

(54) WIRELESS COMMUNICATION APPARATUS AND METHOD

(75) Inventors: Takeshi Tomizawa, Yokohama-shi (JP); Tomoya Tandai, Kawasaki-shi (JP); Tomoko Adachi, Kawasaki-shi (JP)

(73) Assignee: KABUSHIKI KAISHA TOSHIBA, Tokyo (JP)

(21) Appl. No.: 13/223,618

(22) Filed: Sep. 1, 2011

(30) Foreign Application Priority Data
Feb. 28, 2011 (JP) 2011-042696

(51) Int. Cl. H04W 92/00

(52) U.S. Cl. 370/328

(57) ABSTRACT

According to one embodiment, a wireless communication apparatus includes a receiving unit, a transmitting unit and a control unit. The receiving unit is configured to receive a first connection request frame indicating a connection request from another apparatus. The transmitting unit is configured to transmit a connection acceptance frame indicating a response to the first connection request frame. The control unit is configured to control the transmitting unit to retransmit the connection acceptance frame until a first acknowledgement frame addressed to the apparatus as a response to the connection acceptance frame is received from the another apparatus, and control the transmitting unit to stop from transmitting the connection acceptance frame if a second acknowledgement frame addressed to the another apparatus as a destination is received or if a second connection request frame addressed to the another apparatus is received.

### CROSS-REFERENCE TO RELATED APPLICATIONS

This application is based upon and claims the benefit of priority from prior Japanese Patent Application No. 2011-042696, filed Feb. 28, 2011, the entire contents of which are incorporated herein by reference.

### FIELD

Embodiments described herein relate generally to a wireless communication apparatus.

### BACKGROUND

In short-range wireless communication, random backoff of a frame requesting a connection (“C-Req”) and a frame responding to the C-Req (“C-Acc”) is one of the procedures to avoid collision of transmission while keeping fairness.

### BRIEF DESCRIPTION OF THE DRAWINGS

FIG. 1 is a block diagram illustrating a wireless communication apparatus according to the first embodiment.

FIG. 2 is a sequence diagram illustrating an example of the operation of the wireless communication apparatus according to the first embodiment.

FIGS. 3A and 38 are a drawing illustrating an example of tables according to the first embodiment.

FIG. 4 is a sequence diagram illustrating an example of the operation of the wireless communication apparatus according to the second embodiment.

FIGS. 5A and 5B are a drawing illustrating an example of tables according to the second embodiment.

FIG. 6 is a sequence diagram illustrating an example of the operation of the wireless communication apparatus according to the third embodiment.

FIG. 7 is an example of random backoff when there is a hidden node problem.

FIG. 8 is an example of a slot length in random backoff of the connection sequence according to the fourth embodiment.

FIG. 9 is an example of connection sequences when random values in random backoff become the same at a plurality of wireless communication apparatuses.

FIG. 10 is an example of a connection sequence when a wireless communication apparatus fails to receive a B-ACK.

FIG. 11 is a block diagram illustrating the wireless communication apparatus according to the fifth embodiment.

FIG. 12 is a block diagram illustrating the wireless communication apparatus according to the sixth embodiment.

FIG. 13 is a block diagram illustrating the wireless communication apparatus according to the seventh embodiment.

FIG. 14 is a block diagram illustrating the wireless communication apparatus according to the eighth embodiment.

FIG. 15 is a block diagram illustrating the wireless communication apparatus according to the ninth embodiment.

FIG. 16 is a block diagram illustrating the wireless communication apparatus according to the tenth embodiment.

FIG. 17 is a block diagram illustrating the wireless communication apparatus according to the eleventh embodiment.

FIG. 18 is a block diagram illustrating the wireless communication apparatus according to the twelfth embodiment.

FIG. 19 is a block diagram illustrating the wireless communication apparatus according to the thirteenth embodiment.

FIG. 20 is a block diagram illustrating the wireless communication apparatus according to the fourteenth embodiment.

FIG. 21 is a block diagram illustrating the wireless communication apparatus according to the fifteenth embodiment.

FIG. 22 is a block diagram illustrating the wireless communication apparatus according to the sixteenth embodiment.

### DETAILED DESCRIPTION

In one-to-one communication which has no network layer, when a terminal intends to connect other terminals, a transmission origination terminal transmits a C-Req under a state of “unspecified” which indicates that any transmission destination terminal is not specified. Even if the C-Req is received by more than one terminal, a terminal to be connected to the origination terminal can be determined without collision of a C-Acc by transmitting a C-Acc by random backoff. Then, the terminal selected to be connected stops transmitting the C-Acc.

Until a higher protocol determines whether the terminal which has transmitted a C-Acc should be connected to the origination terminal, an ACK which is a frame indicating a response to the C-Acc is not transmitted. Accordingly, until the determination has made, the other terminals riot chosen to be connected to the origination terminal continue retransmitting the C-Acc until a retransmission timer times out, or the number of times reaches an upper limit. As a result, in addition to the problem of wasting power at the terminals, the retransmission is an obstruction to data transmission between the connected terminals, and lowers the transmission rate.

In general, according to one embodiment, a wireless communication apparatus includes a receiving unit, a transmitting unit and a control unit. The receiving unit is configured to receive a first connection request frame indicating a connection request from another apparatus. The transmitting unit is configured to transmit a connection acceptance frame indicating a response to the first connection request frame. The control unit is configured to control the transmitting unit to retransmit the connection acceptance frame until a first acknowledgement frame addressed to the apparatus as a response to the connection acceptance frame is received from the another apparatus, and control the transmitting unit to stop from transmitting the connection acceptance frame if a second acknowledgement frame addressed to the another apparatus as a destination is received or if a second connection request frame addressed to the another apparatus is received.

Wireless communication apparatus and transmitting apparatus according to the embodiments will be described in detail with reference to the accompanying drawings. In the embodiments below, like reference numbers denote like elements, and duplicate explanation.

### First Embodiment

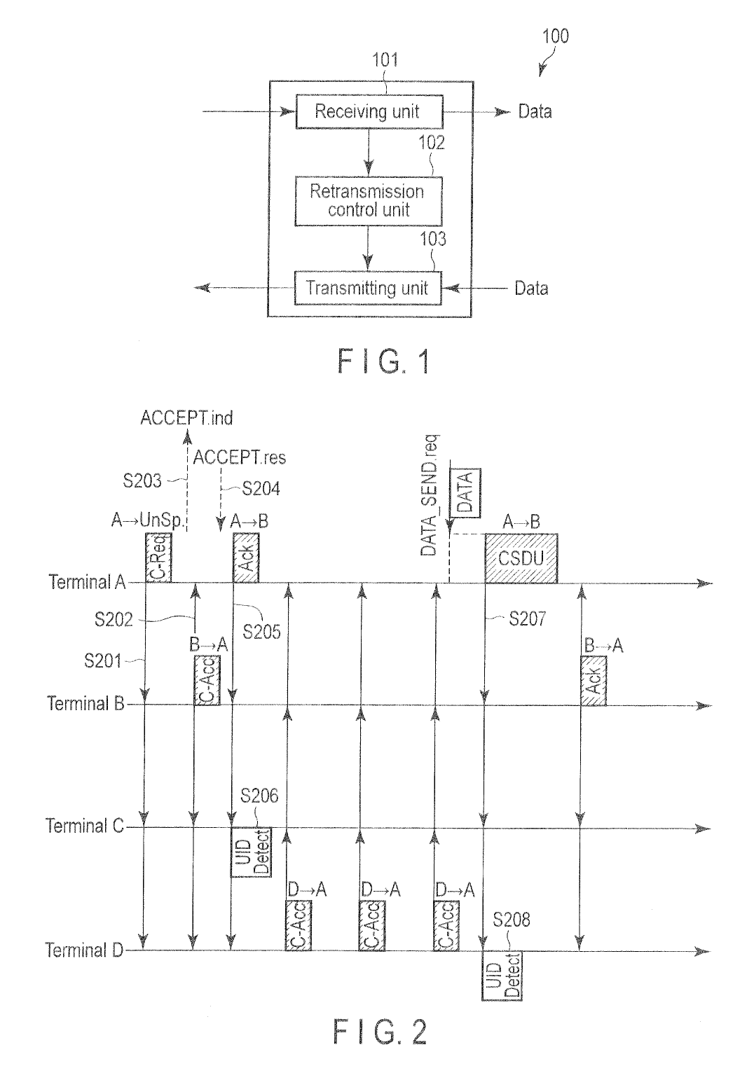

The wireless communication apparatus according to the first embodiment will be explained with reference to the block diagram of FIG. 1. In the present embodiment, the structure of the payload data transmitting side and the structure of the payload data receiving side are the same.

The wireless communication apparatus 100 according to the first embodiment includes a receiving unit 101, a retransmission control unit 102, and a transmitting unit 103. Hereinafter, the wireless communication apparatus also may be called a terminal.

The receiving unit 101 includes functions necessary to demodulate received data, based on the specifications of a wireless communication system, such as an antenna, a filter, a frequency converter, a low-noise amplifier, a demodulator, an error correction decoder, and a header analyzer, etc. The receiving unit 101 receives data from external device, and demodulates and analyzes the frame of the received data to extract payload data and received header information.

In the present embodiment, on the payload data receiving side, the receiving unit 101 receives a connection requirement frame (hereinafter, referred to as a “C-Req”) indicating a request for a connection from other terminal(s) and an acknowledgement frame indicating an acknowledgement of frame transmission and reception (hereinafter, referred to as an “ACK”). The C-Req header information includes a transmission destination address (RxUID) and a transmission origination address (TxUID). Payload data is transferred to appropriate destinations, for example, storage region of a higher protocol management or a host system management, or an external IO.

On the payload data transmitting side, the receiving unit 101 receives a connection acceptance frame (hereinafter, referred to as a “C-Acc”) indicating readiness to accept a connection request in response to a received C-Req, and extracts C-Acc header information.

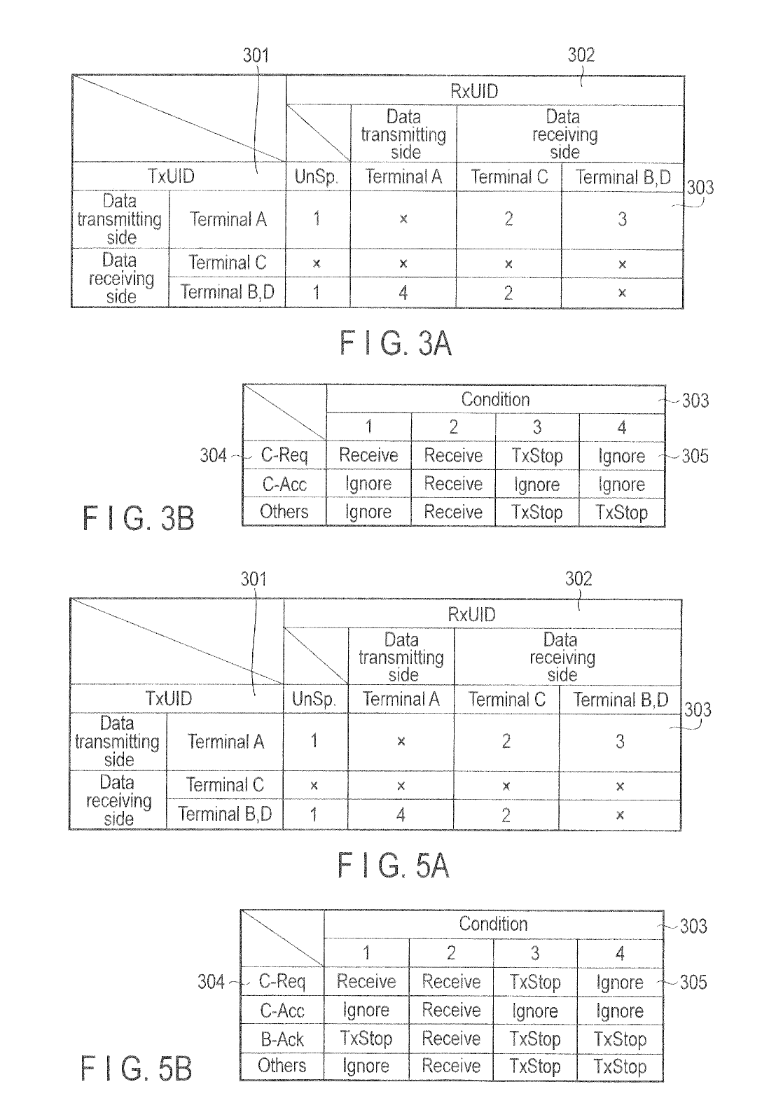

The retransmission control unit 102 receives the header information from the receiving unit 101. On the payload data receiving side, the retransmission control unit 102 refers to a table of correspondences between the transmission origination and destination of a frame and the operation at the retransmission control unit 102, and controls the operation of the whole apparatus, including a determination whether retransmission should be carried out or not, on the basis of a frame type of the header, the transmission destination address and transmission origination address included in the header information, a frame data size, and existence of a reception error. If it is determined to carry out retransmission of frames, the retransmission control unit 102 generates transmission time information indicating a duration or the number of times of retransmission and a duration of frame transmission, and the unit 102 controls the retransmission of frames based on the transmission time information. The table will be described later in detail with reference to FIG. 3.

On the payload data transmitting side, the retransmission control unit 102 controls retransmission by broadcasting a C-Req or designating a destination terminal. The retransmission control unit 102 receives the C-Acc header information item from the receiving unit 101, and notifies the higher protocol of a first primitive (ACCPET.ind) including an ID of the origination terminal. Then, after the higher protocol notifies a second primitive (ACCEPT.res) indicating readiness to accept other terminal which has transmitted the C-Acc, the retransmission control unit 102 controls the transmitting unit 103 to transmit an ACK to the terminal which are now acceptable. On the other hand, if no C-Acc is received from the other terminals during a predetermined period, the retransmission control unit 102 controls the retransmission to retransmit C-Req after the predetermined period of time has elapsed.

The transmitting unit 103 includes functions necessary for modulating transmission data, based on specification of the wireless communication system, such as an antenna, a filter, a frequency converter, a low-noise amplifier, a modulator, an error correction encoder, and a header generator, etc. The transmitting unit 103 receives payload data from the higher protocol and the host system, and the header information and the transmission time information from the retransmission control unit 102, respectively. The transmitting unit 103 generates a frame to include payload data in accordance with instructions from the higher protocol and the host system, modulates a frame including the payload data and the header information, and transmits the frame in accordance with the transmission time information.

In the present embodiment, the transmitting unit 103 on the payload data receiving side transmits a C-Acc in response to a C-Req to other terminal, and the transmitting unit 103 on the payload data transmitting side transmits a C-Req and an ACK.

Next, an example of the operation of the wireless communication apparatus 100 according to the first embodiment is explained with reference to the sequence illustrated in FIG. 2.

In the following, for the sake of explanation, suppose four wireless communication apparatuses 100 involve in a communication. Terminal A is on the payload data transmitting side, terminals B, C and D are on the payload data transmitting side. In FIG. 2, the operation at the connection sequence of the terminals is illustrated in time line, and it is assumed that terminal A transmits a C-Req at fixed intervals, and terminals B, C and D exist within a range where a C-Req sent from terminal A can reach.

In step S201, terminal A broadcasts a C-Req.

In step S202, upon receiving a C-Req from terminal A, then, terminals B, C and D perform random backoff, respectively. To perform random backoff, a common method for determining a random value and transmitting a frame (C-Acc) at a timing based on the random value can be adopted. Then, a C-Acc is transmitted in response to the C-Req at a timing determined by the random backoff for each of terminals B, C and D if there is no radio interference at the timing. The acquisition of a transmission opportunity by the terminal consists of determining a timing for the terminal by random backoff. In the example illustrated in FIG. 2, as the timing determined by the random backoff for terminal B is the earliest among the timings for the other terminals, and there is no signal interference, terminal B acquires a transmission opportunity and sends a C-Acc to terminal A.

In step S203, terminal A which receives a C-Acc from one of the other terminals sends a first primitive to a higher protocol to notify the higher protocol of a terminal which desires to connect to the higher protocol. Upon receiving the first primitive, the higher protocol determines whether the origination terminal that sends the C-Acc to the terminal A should be connected to terminal A.

Usually, it takes a lot longer time to send a first primitive corresponding to the C-Acc received by terminal A to the higher protocol and determine whether the terminal which sent the C-Acc should he connected to terminal A, and notify terminal A of a second primitive than the period of time required for retransmitting a C-Acc at the wireless communication apparatus 100. For this reason, if the origination terminal that has sent the C-Acc to the terminal A fails to receive an ACK frame corresponding to the sent C-Acc from terminal A, or if other terminals which have not acquired a transmission opportunity fail to send a C-Acc, retransmission of the C-Acc is repeated after the next random backoff period. In other words, although not shown in FIG. 2, terminals B, C and D continue retransmitting a C-Acc even after terminal B transmits a C-Acc to terminal A.

In step S204, if the higher protocol of terminal A determines that terminal B which sends the C-Acc should be connected to terminal A, the higher protocol notifies terminal A of a second primitive.

In step S205, after the second primitive is notified, a C-Acc is transmitted to terminal A from terminal B which is to be connected to terminal A, and after an inter frame space (IFS) time which is defined by a wireless system has elapsed, terminal A sends back an ACK to terminal B indicating acceptance of the C-Acc.

In step S206, the terminals having received no ACK frames which are addressing themselves extract header information of a frame when they receive any frame. Then, the terminals determine whether they should stop retransmission of the C-Acc or not, based on an origination address, a destination address and a table included in the extracted header information. In the example illustrated in FIG. 2, terminals C and D continue retransmitting the C-Acc; however, they are standby for receiving frames while they are not transmitting any frames, and if any frame is received, they extracts header information of the frame. If terminal C determines that the ACK frame sent by terminal A is addressed to terminal B and not to itself, terminal C stops retransmitting the C-Acc. Thus, excess power consumption caused by unnecessary retransmission can be reduced.

In step 3207, upon receiving an ACK frame, the terminal is in connection with terminal A, and the terminal enters from the connection sequence to the data communication sequence to start data communication. In the communication sequence, CNL service data unit (CSDU) is transmitted from terminal A to terminal B to carry out data communication. For data communication, a common scheme can be used. A specific explanation of communication scheme is omitted.

In step S208, a terminal which has not stopped retransmitting the C-Acc during the connection sequence continues extracting header information of data, even if one of the other terminals has already entered from the connection sequence to the data communication sequence. The terminal stops retransmitting the C-Acc when it determines that a destination of the data included in the header information is not itself, referring to the table. FIG. 2 shows that terminal D receives CSDU from terminal A and extracts header information therefrom, and if it determines that the data is not addressed to itself, terminal D stops retransmitting the C-Acc.

Next, tables which the retransmission control unit 102 refers to will be explained with reference to FIGS. 3A and 3B.

FIG. 3 shows an example of tables referred to at terminal C of FIG. 2. Accordingly, the wireless communication apparatus 100 on the payload data transmission side corresponds to terminal A, and among the wireless communication apparatuses 100 on the payload data reception side, self-terminal corresponds to terminal C, other terminals correspond to terminals B and D. In the present embodiment, the table may be stored in the retransmission control unit 120, or the retransmission control unit 102 may refer to an externally stored table.

FIG. 3A is a table of correspondences among an origination address 301, a destination address 302, and a condition 303 of the retransmission control unit 102. FIG. 3B is a table an operation 305 of the retransmission control unit 102 in accordance with a frame type in each condition 303.

The origination address “UnSp.” in FIG. 3A indicates that terminal A transmits a frame to unspecified terminals; in other words, a frame is broadcast. In FIG. 3B, “Receive” means that a frame is received and a process corresponding to a frame type is carried out; “Ignore” means that a received frame is ignored and a previous operation is continued; and “TxStop” means retransmission of an C-Ace is stopped. The label “Others” in the frame type column includes an ACK and a CSDU.

Each communication apparatus on the payload data receiver side (terminals B, C and D) extracts the origination address 301 and the destination address 302 included in the header information, and compares the extracted origination address 301 and destination address 302 with own address. Then, the apparatus determines which Conditions 1 to 4 303 the result of the comparison corresponds to by referring to FIG. 3A, and then, the operation 305 of the retransmission control unit 102 is determined based on Conditions 1 to 4 and the frame type 304 of the received frame.

For example, as shown in FIG. 2, suppose that terminal A sends an ACK to terminal B. When terminal C extracts the header information of the received ACK, it turns out that the origination address 301 of the frame is terminal A and the destination address 302 of the frame is terminal B. Thus, as the frame received from terminal A is not addressed to terminal C, the condition 303 is determined as Condition 3 according to FIG. 3A. Because the frame is an ACK, the frame type 304 is “Others” in FIG. 3B, so that, for the Condition 3 status, the operation 305 of the retransmission control unit 102 is “TxStop.” Terminal C therefore stops retransmitting the C-Acc.

According to the first embodiment described above, if a frame which is addressed to other terminals is received, retransmission of the C-Acc is stopped in accordance with the origination address and destination address included in the frame header information and the table. Thus, it is possible to reduce power consumption caused by unnecessary retransmission in a conventional wireless system. Furthermore, since transmission of unnecessary radio signals is prevented, it is possible to prevent degradation of data transmission rate in data communication.

### Second Embodiment

In the second embodiment, a wireless communication apparatus which receives a C-Acc transmits a Broadcast-ACK (B-ACK) which is a frame indicating an acknowledgement addressed to unspecified terminals, and a wireless communication apparatus receives the B-ACK must stop retransmitting a C-Acc. This compulsory stoppage of C-Acc retransmission is different from the first embodiment. The second embodiment can achieve reduction of power consumption by a terminal for transmitting and receiving frames during the time to wait a connection decision.

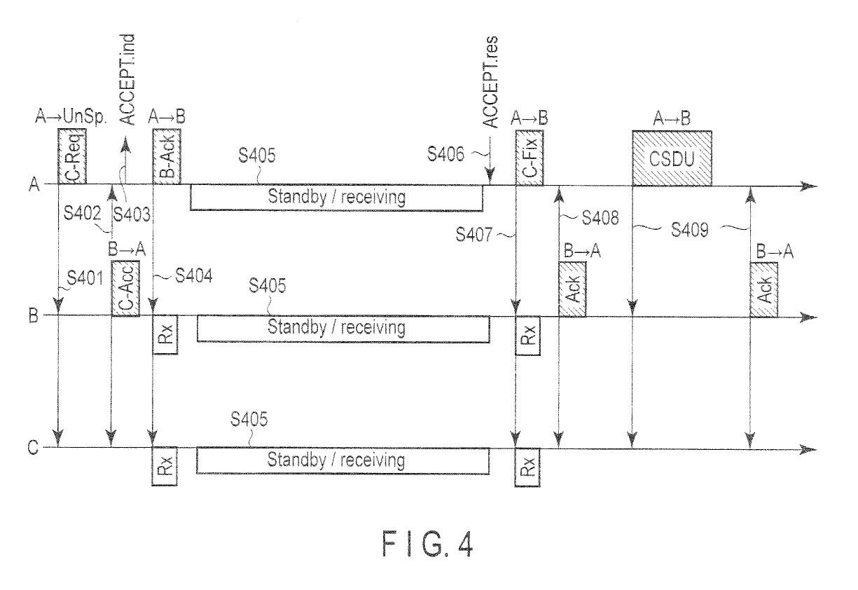

An example of the operation of the wireless communication apparatus according to the second embodiment is explained with reference to the sequence of FIG. 4. Suppose terminal A is a wireless communication apparatus 100 on the payload data transmitting side, terminals B and C are wireless communication apparatuses 100 on the payload data transmitting side.

In step S401, terminal A broadcasts a C-Req to unspecified terminals.

In step S402, either terminal B or C acquires a transmission opportunity and transmits a C-Acc to terminal A by random backoff. In this example, terminal B sends a C-Acc to terminal A.

In step S403, terminal A sends a first primitive to notify the higher protocol of a terminal which has sent a C-Ace.

In step S404, when terminal A receives a C-Acc from one of the terminals (in this example, the C-Acc from terminal B is received.), terminal A transmits a B-ACK after an IFS time which is defined by the wireless system elapsed. Herein, the B-ACK is an ACK frame indicating the ID of terminal A as the origination address and “unspecified” as the ID of the destination address.

In step S405, terminals B and C receive the B-ACK and stop retransmitting C-Acc. Terminal A shifts to a standby/receiving state to wait until the higher protocol sends a second primitive to notify a result of connection decision. Thus, power consumption at each terminal can be reduced.

In step S406, terminal A receives a second primitive from the higher protocol.

In step S407, terminal A transmits a connection notification frame which designates the other end of connection (hereinafter, referred to as “C-Fix (Connect-Fix)”). A C-Fix includes a destination address of a terminal to which a connection acceptance is given. A C-Fix can be used as a notification frame addressed to multiple terminals by setting unspecified ID as the destination address.

In step S408, when the C-Fix is received by a terminal corresponding to the destination address included in the C-Fix, the terminal transmits an ACK frame. If the C-Fix is received by a terminal not corresponding to the destination address, the terminal does not retransmit a C-Acc and is in a state to wait for a connection process, e.g., an initial search status. In the example shown in FIG. 5, terminal B is as a destination address included in the C-Fix, terminal B transmits an ACK to terminal A. Terminal C extracts an ID included in the C-Fix to determine that terminal B is designated as a destination, and continues stopping retransmitting a C-Acc.

In step S409, terminals which a connection is established therebetween perform data communication. During the communication, terminal A transmits a CSDU and terminal B transmits an ACK indicating reception of the CSDU from terminal A. The transmitting of the frames is repeated to perform the data communication.

Next, an example of the table which the retransmission control unit 102 according to the second embodiment refers to is explained with reference to FIGS. 5A and 5B.

The table of FIGS. 5A and 5B are almost the same as the table of FIGS. 3A and 3B, except that “B-ACK” is added as a frame type 304 in the table of FIG. 5B. As shown in FIG. 5B, when a B-ACK which is broadcast is received, the retransmission control unit 102 is controlled to stop retransmitting a C-Acc.

When a terminal receives a B-ACK which is addressed not to itself but to a specific terminal designated as a destination of the B-ACK, power consumption can be reduced by stopping retransmitting an C-Acc.

According to the second embodiment explained above, a wireless communication apparatus which has received a B-ACK stops retransmitting a C-Acc, and a wireless communication apparatus which has transmitted a B-ACK shifts to a standby/receiving status, so that retransmission of C-Acc can be prevented when the apparatus awaits until a decision as to whether a connection acceptance is given from the higher protocol or not is made. As a result, power consumption at the wireless communication device can be reduced.

### Third Embodiment

The third embodiment is different from the foregoing first and second embodiments with respect to the timing of B-ACK transmission. In the present embodiment, a B-ACK is transmitted after a maximum-length backoff period elapsed. Thus, a terminal which receives a C-Req can transmit a C-Acc at least once, and thus, a terminal which sends the C-Req can choose which terminal to be connected to.

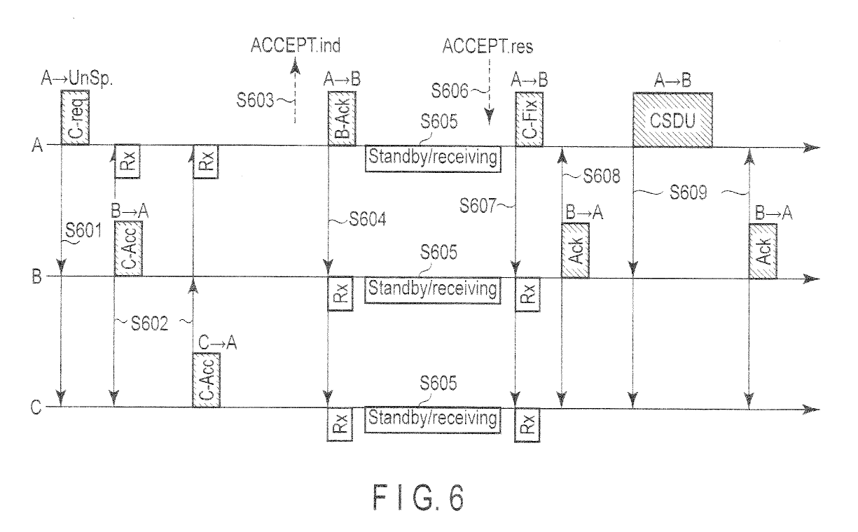

An example of the operation of the wireless communication apparatus according to the third embodiment is explained with reference to the sequence of FIG. 6. Similarly to FIG. 4, suppose terminal A is a wireless communication apparatus 100 on the payload data transmitting side, terminals B and C are wireless communication apparatuses 100 on the payload data transmitting side.

In step S601, terminal A broadcast a C-Req to the other terminals.

In step S602, each terminal which has received the C-Req transmits a C-Acc when they acquire a transmission opportunity by random backoff. Terminal A does not transmit a B-ACK during the IFS period even after terminal A receives a C-Acc from one of the terminals. Terminal A transmits a B-ACK only after a maximum-length backoff period defined by the wireless communication system elapsed.

More specifically, in the example illustrated in FIG. 6, terminal A receives the C-Acc transmitted from terminal C without sending a B-ACK right after receiving the C-Acc from terminal B. If terminal A receives no C-Acc at all, terminal A retransmits a C-Req after a maximum-length backoff period has elapsed, and continues the C-Req retransmission until it receives a C-Acc.

As the process from step S603 to step S609 is the same as that from step S403 to step S409 in the second embodiment, the detailed explanation of the process is omitted.

According to the third embodiment above, as each of wireless communication apparatuses which have received a C-Req can transmit a C-Acc at least once before a B-ACK is sent back, the probability that a wireless communication apparatus on the payload transmitting side receives a C-Acc transmitted from multiple wireless communication apparatuses is improved. Accordingly, a higher protocol can determine a connection permission to multiple wireless communication apparatuses at the same time; as a result, a time necessary for a wireless communication apparatus which is a target for connection to acquire a transmission opportunity by random backoff can be shortened, and a time necessary to establish a connection can be shortened.

### Fourth Embodiment

In the fourth embodiment, in the event of a hidden terminal problem, a slot length that defines the duration of random backoff is set to the same as the length of a C-Acc.

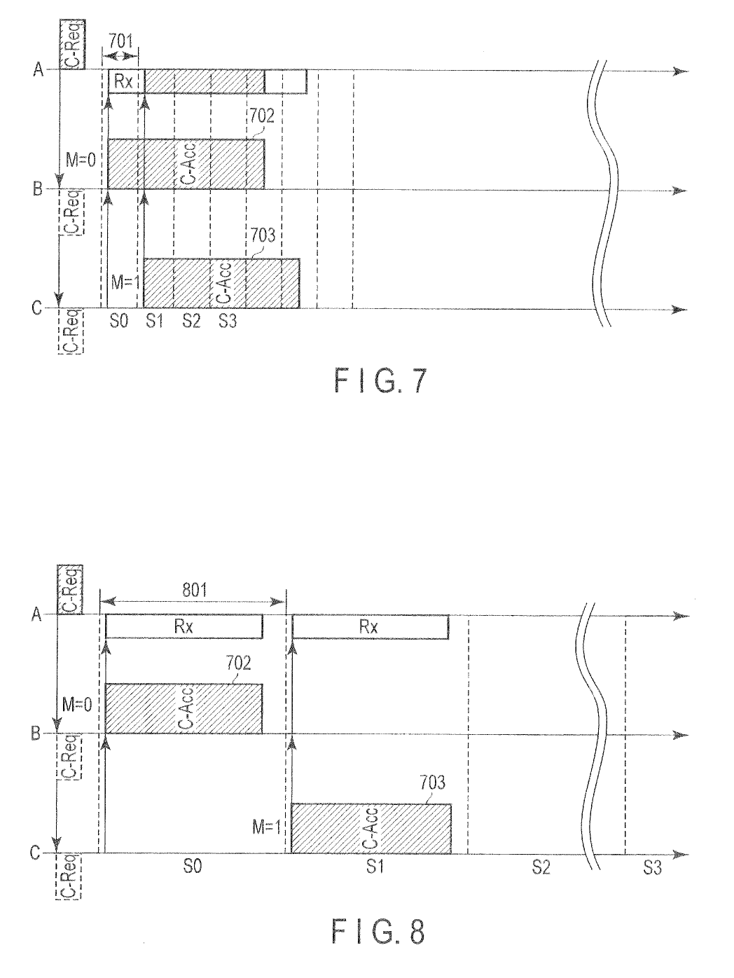

An example of common random backoff carried out in the event of a hidden terminal problem is shown in FIG. 7.

Usually, when terminal A sends a C-Req and terminals B and C receive the C-Req, each of terminals B and C determines a random value and sends a frame on a timing in accordance with the random value. The transmission timing determined by the random backoff can be obtained by a result of multiplication of the random value with a slot which indicates a unit time. A time length of a slot often include a time required for transmission/reception switching at a wireless apparatus, or a time for sensing power and pilot signals. The time length is often shorter than a time length of a C-Acc frame; accordingly, once a terminal which acquires a transmission opportunity first among the other terminals starts transmitting a C-Acc, the other terminals which acquire a transmission opportunity after the first acquisition of the transmission opportunity cannot transmit a frame, because the channel is busy. As a result, the other terminals have to attempt to retransmit a frame.

Here, suppose if a signal power strong enough to perform communication can be obtained between terminal A and terminal B or between terminal A and terminal C, whereas a signal power is too weak to perform communication between terminal B and terminal C; in other words, there is a hidden terminal problem.

As shown in FIG. 7, suppose if the length of a C-Acc is approximately the same as the length of four slots 701. First, terminals B and C calculates random values Mb and Mc for the C-Req transmitted from terminal A, and suppose if Mb=0, Mc=1. Terminal B starts transmitting a C-Acc 702 at the beginning of the first slot of the four slots 701.

Terminal C carries out power detection before transmitting a frame at the next slot to see if the state of air propagation is busy or idle. If terminals B and C are not hidden terminals, terminal C can detect a power level of the C-Acc 702 transmitted from terminal B, and terminal C cancels transmitting C-Acc 703.

However, if terminals B and C are hidden terminals, terminal C cannot detect a power level of the C-Acc 702 from terminal B, and then, terminal C transmits C-Acc 703. In this case, terminal A receives both of the C-Acc 703 from terminal A and the C-Acc 702 from terminal B; as a result, a reception error occurs due to collision of the C-Acc 702 and the C-Acc 703.

Herein, the setting of slot length according to the fourth embodiment is explained with reference to FIG. 8.

As shown in a slot 801 of FIG. 8, the slot length is determined to be longer than the frame length of each of the C-Acc 702 and the C-Acc 703. By setting the slot length in such a manner, it is possible to avoid collision of C-Acc transmitted from multiple terminals even when transmission timings are controlled by random backoff.

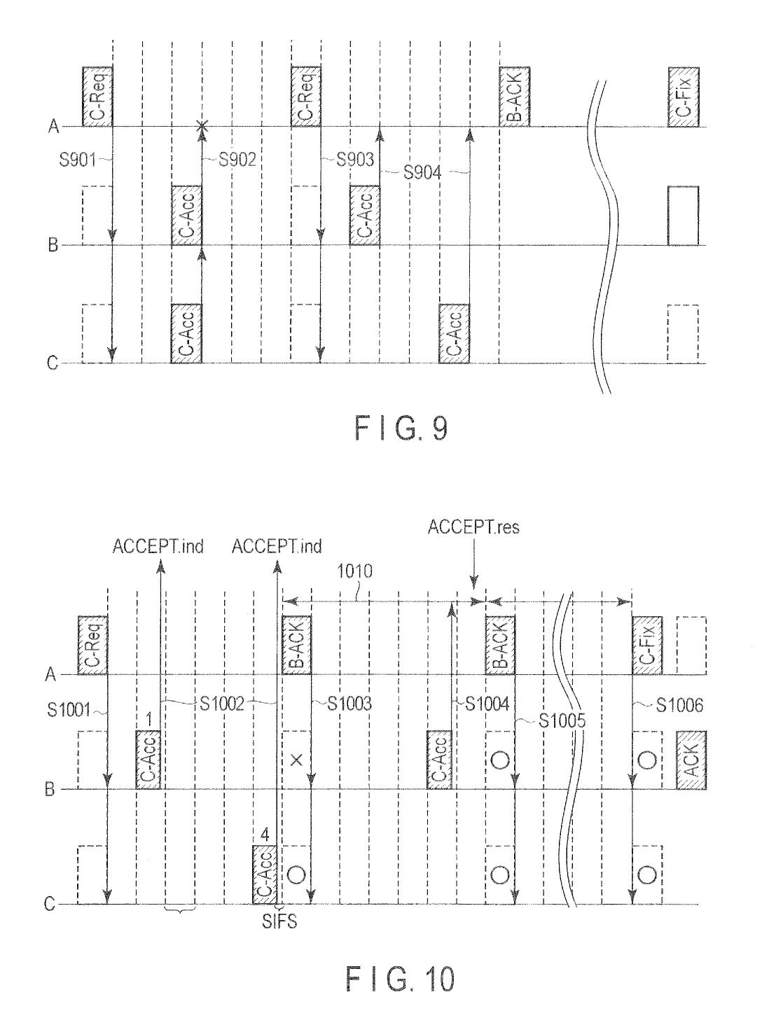

Next, a sequence in which a random value for random backoff becomes the same value at multiple terminals is explained with reference to FIG. 9.

In step S901, terminal A transmits a C-Req.

In step S902, terminals B and C transmit a C-Acc at the same time. As a result, a reception error occurs at terminal A, as the C-Acc from those terminals collide.

In step S903, if there is no terminal which successfully receives a C-Acc, terminal A retransmits a C-Req after a period longer than the maximum-length random backoff period has elapsed since the first transmission of a C-Req.

In step S409, random backoff is carried out once again for terminals B and C, and a C-Acc is transmitted to terminal A. It is a rare case that random values become the same value in a row. Accordingly, it can be assumed that the random value for each of terminal B and C are different. Consequently, terminal A can receives a C-Acc from each of the terminals.

Next, a sequence in which a terminal fails to receive a B-ACK is explained with reference to FIG. 10.

In step S1001, terminal A transmits a C-Req.

In step S1002, each of terminals B and C transmits a C-Acc to terminal A.

In step S1003, terminal A transmits a B-ACK. Suppose terminal B fails to receive the B-ACK.

In step S1004, terminal B which failed to receive the B-ACK retransmits a C-Acc at the next backoff period.

In step S1005, after transmitting the B-ACK and before the maximum-length backoff period 1010 elapses, terminal A transmits another B-ACK when terminal A receives the C-Acc while a second primitive is notified from the higher protocol of terminal A.

In step S1006, if terminal A does not receive any C-Acc even after the next maximum-length backoff period 1010 elapsed, terminal A transmits a C-Fix to start communication with a terminal connected to terminal A (in this example, terminal B). By this operation, even in the event of a hidden terminal problem, communication can be started smoothly without raising a probability of reception error caused by collision in the connection sequence.

According to the fourth embodiment explained above, in the event of a hidden terminal problem, collision of C-Acc in random backoff by setting a slot length that defines a random backoff period at the same as the length of a C-Acc.

### Fifth Embodiment

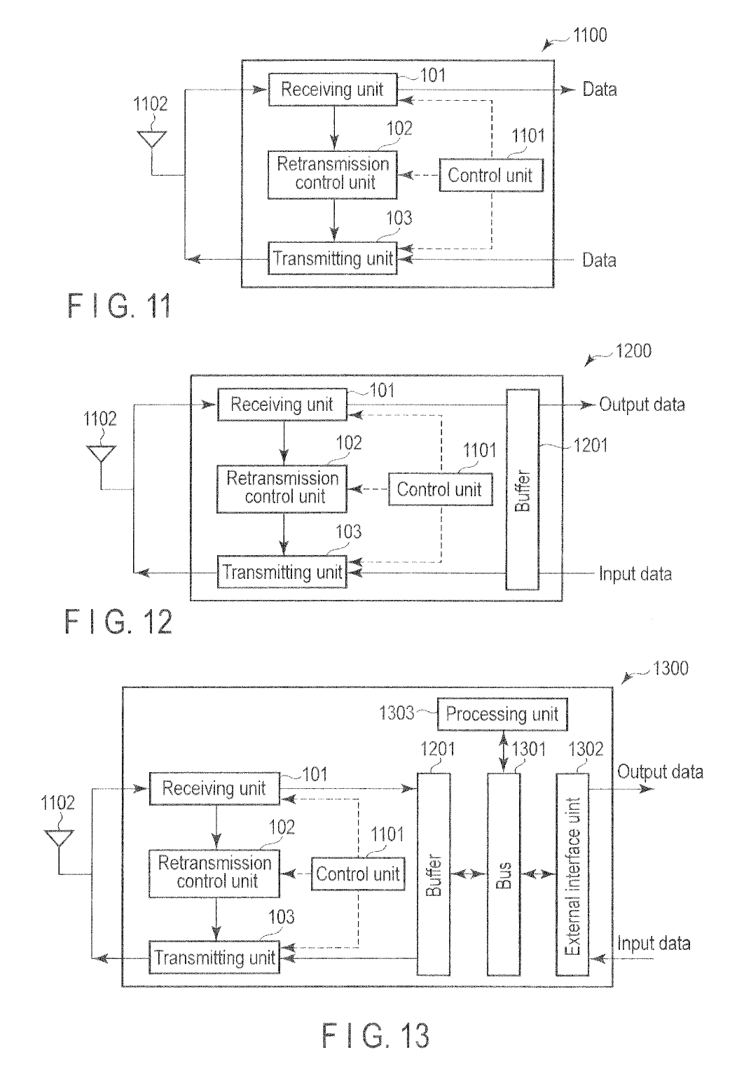

The wireless communication apparatus according to the fifth embodiment will be explained with reference to the block diagram of FIG. 11.

The wireless communication apparatus 1100 according to the fifth embodiment is a structure that the wireless communication apparatus according to the first embodiment further includes a control unit 1101 and an antenna 1102.

The control unit 1101 controls the operation of entire of the receiving unit 101, the retransmission control unit 102 and the transmitting unit 103.

The antenna 1102 is connected the receiving unit 101 and the transmitting unit 103. With the structure that the antenna 1102 can be integrally formed with the wireless communication apparatus 100, a small foot-print wireless communication apparatus can be provided. In addition, the antenna 1102 which is used both for transmission and reception processes can realize a small-sized wireless communication apparatus.

### Sixth Embodiment

The wireless communication apparatus according to the sixth embodiment will be explained with reference to the block diagram of FIG. 12.

The wireless communication apparatus 1200 according to the sixth embodiment is a structure that the wireless communication apparatus 1100 according to the fifth embodiment further includes a buffer 1201. The buffer 1201 is connected to the receiving unit 101 and the transmitting unit 103. This structure can realize retransmission or external output processing easily since the buffer 1201 stores transmitting data and receiving data.

### Seventh Embodiment

The wireless communication apparatus according to the Seventh embodiment will be explained with reference to the block diagram of FIG. 13.

The wireless communication apparatus 1300 according to the seventh embodiment is a structure that the wireless communication apparatus 1200 according to the fifth embodiment further includes a bus 1301, an external interface unit 1302 and a processor unit 1303. The bus is connected to the buffer 1201, and the external interface unit 1302 and the processor unit 1303 are connected to the buffer via the bus 1301. The processor unit 1303 includes firmware. Such a wireless communication apparatus which includes the firmware can change the functions easily by rewriting the firmware.

### Eighth Embodiment

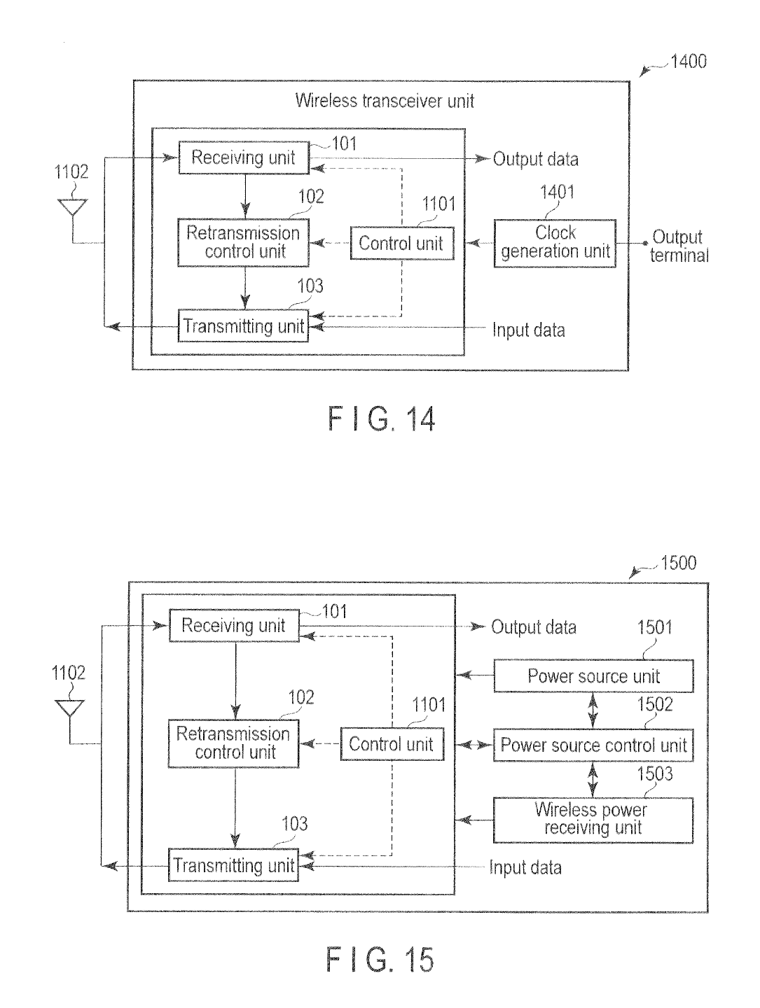

The wireless communication apparatus according to the eighth embodiment will be explained with reference to the block diagram of FIG. 14.

The wireless communication apparatus 1400 according to the eighth embodiment is a structure that the wireless communication apparatus 1100 according to the fifth embodiment further includes a clock generation unit 1401. The clock generation unit 1401 generates a clock and outputs it externally via an output terminal. The clock generated within the wireless communication apparatus is externally output to activate the host. This can realize operation in synchronism with between the host and the wireless communication apparatus.

### Ninth Embodiment

The wireless communication apparatus according to the ninth embodiment will be explained with reference to the block diagram of FIG. 15.

The wireless communication apparatus 1500 according to the ninth embodiment is a structure that the wireless communication apparatus 1100 according to the fifth embodiment in FIG. 11 further includes a power source unit 1501, a power control unit 1502 and a wireless power feeding unit 1503. The power control unit 1502 is connected to the power source unit 1501 and the wireless power feeding unit 1503 and a wireless transceiver unit. The power source unit 1501 and the wireless power feeding unit 1503 are connected to the wireless transceiver unit. Such a structure can realize low power operation by selectively controlling the power sources.

### Tenth Embodiment

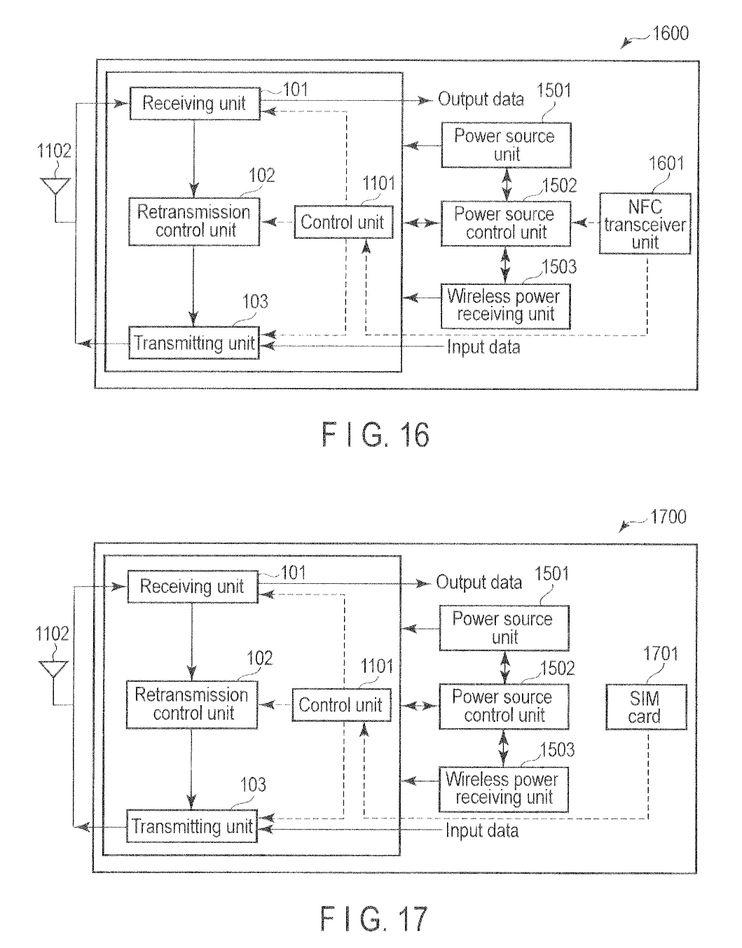

The wireless communication apparatus according to the tenth embodiment will be explained with reference to the block diagram of FIG. 16.

The wireless communication apparatus 1600 according to the tenth embodiment is a structure that the wireless communication apparatus 1500 according to the ninth embodiment in FIG. 15 further includes a near field communications (NFC) transceiver unit 1601. The NFC transceiver unit 1601 is connected to the power control unit 1502. This structure can facilitate an authentication processing and decrease energy consumption during waiting mode by controlling the power source by using a signal received in the NFC transceiver unit as a trigger.

### Eleventh Embodiment

The wireless communication apparatus according to the eleventh embodiment will be explained with reference to the block diagram of FIG. 17.

The wireless communication apparatus 1700 according to the Eleventh embodiment is a structure that the wireless communication apparatus 1300 according to the seventh embodiment in FIG. 13 further includes a SIM card 1701, wherein the SIM card 1701 is connected to the control unit 1101. The wireless communication apparatus including the SIM card 1701 can perform authentication process easily.

### Twelfth Embodiment

The wireless communication apparatus according to the twelfth embodiment will be explained with reference to the block diagram of FIG. 18.

The wireless communication apparatus 1800 according to the twelfth embodiment is a structure that the wireless communication apparatus 1300 according to the seventh embodiment in FIG. 13 further includes a moving picture compander unit 1801. The moving picture compander unit 1801 is connected to the bus 1301. This structure can facilitate transmission of compressed moving pictures and expansion of received compressed moving pictures.

### Thirteenth Embodiment

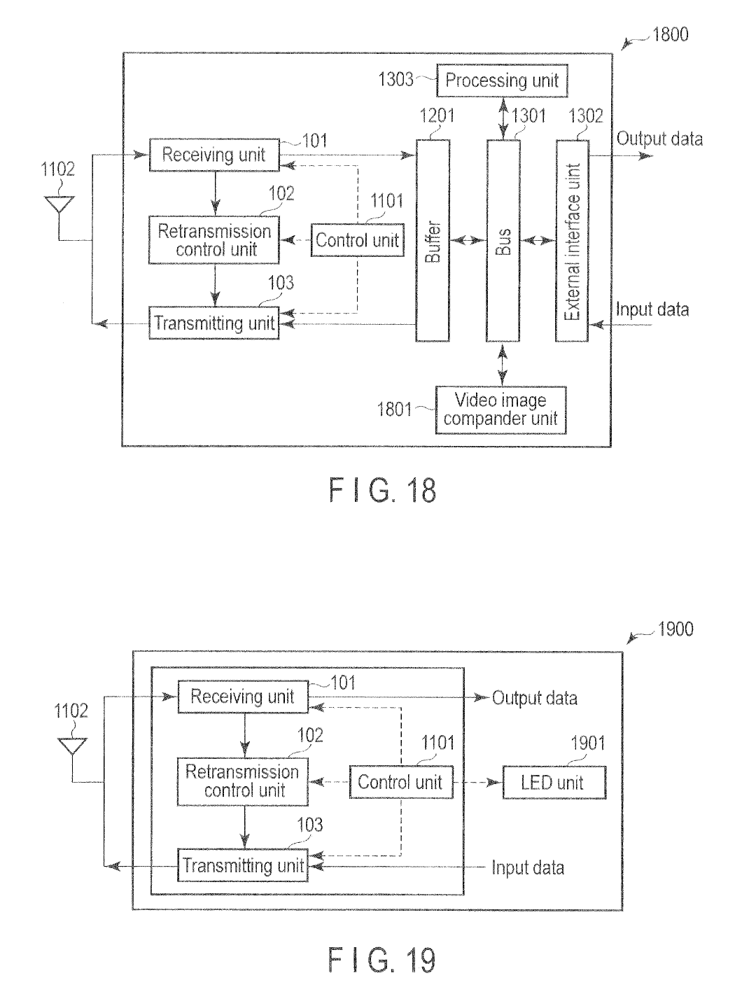

The wireless communication apparatus according to the Thirteenth embodiment will be explained with reference to the block diagram of FIG. 19.

The wireless communication apparatus 1900 according to the thirteenth embodiment is a structure that the wireless communication apparatus 1100 according to the fifth embodiment in FIG. 11 further includes an LED unit 1901. The LED unit 1901 is connected to the control unit 1101. With this structure, notification of the operational state of the wireless communication apparatus can be easily made to a user.

### Fourteenth Embodiment

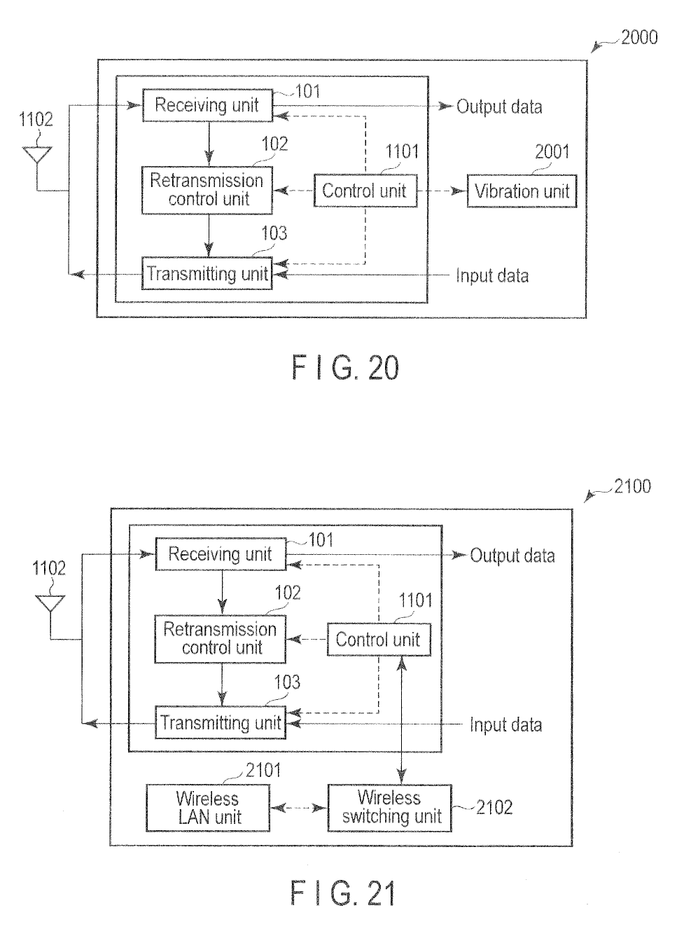

The wireless communication apparatus according to the fourteenth embodiment will be explained with reference to the block diagram of FIG. 20.

The wireless communication apparatus 2000 according to the fourteenth embodiment is a structure that the wireless communication apparatus 1100 according to the fifth embodiment in FIG. 11 further includes a vibrator 2001. The vibrator 2001 is connected to the control unit 1101. With this structure, notification of the operational state of the wireless communication apparatus can be easily made to a user.

### Fifteenth Embodiment

The wireless communication apparatus according to the fifteenth embodiment will be explained with reference to the block diagram of FIG. 21.

The wireless communication apparatus 2100 according to the fifteenth embodiment is a structure that the wireless communication apparatus 1100 according to the fifth embodiment in FIG. 11 further includes a wireless LAN unit 2101 and a wireless switching unit 2102. The wireless LAN unit 2101 is connected to the wireless switching unit 2102. The wireless switching unit 2102 is connected to the wireless transceiver unit and the wireless LAN unit 2102. With this structure, communications via the wireless LAN and via the wireless transceiver unit can be switched depending on the location and the situation.

### Sixteenth Embodiment

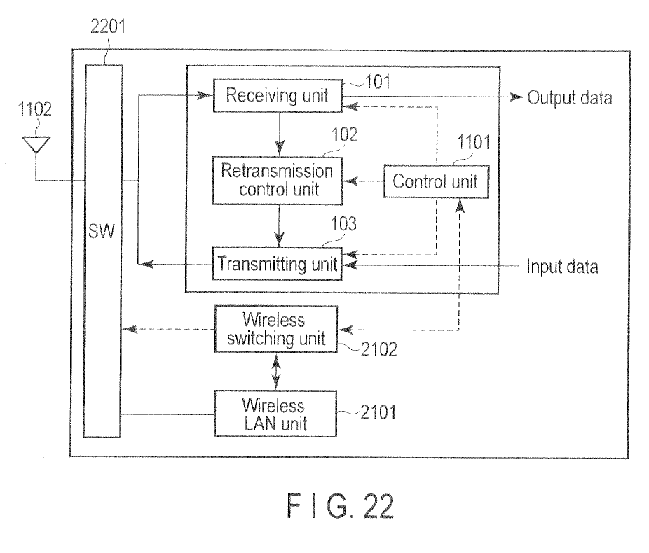

The wireless communication apparatus according to the sixteenth embodiment will be explained with reference to the block diagram of FIG. 22.

The wireless communication apparatus 2200 according to the sixteenth embodiment is a structure that the wireless communication apparatus 2100 according to the fifteenth embodiment in FIG. 21 further includes a switch (SW) 2201. The switch 2201 is connected to between the antenna 1102 and the wireless transceiver unit and the wireless LAN unit 2101. With this structure, communications via the wireless LAN and via the wireless transceiver unit can be switched depending on the location and the situation by sharing the antenna by the wireless transceiver unit and the wireless LAN unit 2101.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus, comprising:
a receiving unit configured to receive a first connection request frame indicating a connection request from another apparatus;
a transmitting unit configured to transmit a connection acceptance frame indicating a response to the first connection request frame; and
a control unit configured to control the transmitting unit to retransmit the connection acceptance frame until a first acknowledgement frame addressed to the apparatus as a response to the connection acceptance frame is received from the another apparatus, and control the transmitting unit to stop from transmitting the connection acceptance frame if a second acknowledgement frame addressed to the another apparatus as a destination is received or if a second connection request frame addressed to the another apparatus is received.

2. The apparatus according to claim 1, wherein the second acknowledgement frame comprises an address indicating that the frame is to be broadcast as a destination of the second acknowledgement frame.

3. The apparatus according to claim 1, wherein the second acknowledgement frame comprises an address indicating the another apparatus as a destination of the second acknowledgement frame.

4. The apparatus according to claim 1, wherein a slot length indicating a unit time to determine the random backoff is longer than a length of the connection acceptance frame, if frames are transmitted by random backoff.

5. A wireless communication apparatus, comprising:
a transmitting unit configured to transmit a connection request frame;
a receiving unit configured to receive a connection acceptance frame indicating a response to the connection request frame; and
a control unit configured to control the transmitting unit to transmit an acknowledgement frame indicating a response to the connection acceptance frame if more than one connection acceptance frame is received during a first period of time, and to control the transmitting unit to retransmit the connection request frame, if no connection acceptance frame is received, after a second period of time longer than a maximum-length period required for random backoff at one or more other apparatuses which are target for connection.

6. The apparatus according to claim 5, wherein the control unit controls the transmitting unit to transmit the acknowledgement frame at a timing which is originally allocated to transmit a next connection request frame, if one or more connection acceptance frames are received.

7. The apparatus according to claim 5, wherein the acknowledgement frame comprises an address indicating that the frame is broadcast as a destination of the acknowledgement frame.

8. The apparatus according to claim 5, wherein the control unit controls the apparatus to shift to a standby state for period after transmitting the acknowledgement frame, and after the period has elapsed, to transmit a connection notification frame to designate another apparatus to be connected to.

9. A method for operating a wireless communication apparatus, comprising:
receiving a first connection request frame indicating a connection request from another apparatus;
transmitting a connection acceptance frame indicating a response to the first connection request frame; and
controlling the apparatus to retransmit the connection acceptance frame until a first acknowledgement frame addressed to the apparatus as a response to the connection acceptance frame is received from the another apparatus, and controlling the apparatus to stop from transmitting the connection acceptance frame if a second acknowledgement frame addressed to the another apparatus as a destination is received or if a second acknowledgement frame addressed to the another apparatus is received.

10. The method according to claim 9, wherein the second acknowledgement frame comprises an address indicating that the frame is to be broadcast as a destination of the second acknowledgement frame.

11. The method according to claim 9, wherein the second acknowledgement frame comprises an address indicating the another apparatus as a destination of the second acknowledgement frame.

12. The method according to claim 9, wherein a slot length indicating a unit time to determine the random backoff is longer than a length of the connection acceptance frame, if frames are transmitted by random backoff.
